(19) United States
(12) Patent Application Publication
(10) Pub. No.: US 2022/0262002 A1
(43) Pub. Date: Aug. 18, 2022

(54) FEEDBACKWARD DECODER FOR PARAMETER EFFICIENT SEMANTIC IMAGE SEGMENTATION

(71) Applicant: Optimum Semiconductor Technologies Inc., Tarrytown, NY (US)

(72) Inventors: Beinan WANG, White Plains, NY (US); John GLOSSNER, Nashua, NH (US); Sabin Daniel IANCU, Pleasantville, NY (US)

(73) Assignee: Optimum Semiconductor Technologies Inc., Tarrytown, NY (US)

(21) Appl. No.: 17/623,714

(22) PCT Filed: Jun. 30, 2020
(86) PCT No.: PCT/US2020/040236

§ 371 Date: Dec. 29, 2021

Related U.S. Application Data
(60) Provisional application No. 62/869,253, filed on Jul. 1, 2019.

(51) Int. Cl. G06T 7/10; G06T 3/40

(52) U.S. Cl. CPC G06T 7/10; G06T 2207/20081; G06T 2207/20084; G06T 3/4046

(57) ABSTRACT

A system and method relating to constructing an encoder and decoder neural network for providing semantic image segmentation includes generating an encoder comprising encoding convolution layers, each of the encoding convolution layers specifying an encoding filter operation using a respective first filter kernel, generating a decoder corresponding to the encoder, the decoder comprising decoding convolution layers, each of the decoding convolution layers being associated with a corresponding encoding convolution layer, and each of the decoding convolution layers specifying a decoding filter operation using a respective second filter kernel derived from the first filter kernel of the corresponding encoder convolution layer, and providing an input image to the encoder and the decoder for semantic image segmentation.

### CROSS-REFERENCE TO RELATED APPLICATION

This application claims priority to U.S. Provisional Application 62/869,253 filed Jul. 1, 2019, the content of which is incorporated by reference in its entirety.

### TECHNICAL FIELD

The present disclosure relates to detecting objects in an image, and in particular, to a system and method of a feedbackward decoder for parameter-efficient semantic image segmentation.

### BACKGROUND

Computer systems programmed to detect objects in an environment have a wide range of industrial applications. For example, an autonomous vehicle may be equipped with sensors (e.g., Lidar sensor and video cameras) to capture sensor data surrounding the vehicle. Further, the autonomous vehicle may be equipped with a computer system including a processing device to execute executable code for detecting the objects surrounding the vehicle based on the sensor data.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a system for semantic image segmentation according to an implementation of the present disclosure.

FIG. 2 depicts a flow diagram of a method to detect objects in an image using semantic image segmentation including a feedbackward decoder according to an implementation of the present disclosure.

FIG. 3 shows an example of the fully convolutional layers that can be divided into five blocks based on the number of output channels according to an implementation of the disclosure.

FIG. 4 depicts a flow diagram of a method to construct an encoder and decoder network and to apply the encoder and decoder to an input image according to an implementation of the present disclosure.

FIG. 5 depicts a block diagram of a computer system operating in accordance with one or more aspects of the present disclosure.

### DETAILED DESCRIPTION

Image-based object detection approaches may rely on machine-learning to automatically detect and classify objects in an image. One of the machine-learning image segmentation approaches is the semantic segmentation. Given an image (e.g., an array of pixels, where each pixel is represented by one or more channels of intensity values (e.g., red, green, blue values, or range data values)), the task of image segmentation is to identify regions in the image according to the scene shown in the imager. Semantic segmentation may associate each pixel of an image with a class label (e.g., a label for a human object, a road, or a cloud), where the number of classes may be pre-specified. Based on the class labels associated with pixels, objects in the image may be detected using an object detection layer.

To this end, current implementations of semantic image segmentation may employ an encoder-decoder network to perform the classification task. The encoder may include convolutional layers referred to as a fully convolutional network. A convolutional layer may include applying a filter (referred to as a kernel) on an input data (referred to as an input feature map) to generate a filtered feature map (referred to as an output feature map), and then optionally applying a max pooling operation on the filtered feature map to reduce the filtered feature map to a lower resolution (i.e., smaller size). For example, each filter layer may reduce the resolution by half. A kernel may correspond to a class of objects. When there are multiple classes of objects, multiple kernels may be applied to the feature map to generate the lower-resolution filtered feature maps. Although a fully connected layer may achieve the detection of objects in an image, the fully connected layer (which does not reduce the image resolution through layers) is associated with a large set of weight parameters that may require a lot of computer resources to learn. Compared with the fully connected layers, the convolutional layer reduces the size of the feature map and thus makes pixel-level classification more computationally feasible and efficient to implement. Although the multiple convolutional layers may generate a set of rich features, the process of layered convolution and pooling reduces the spatial resolution of object detection.

To address the deficiencies of the low spatial resolution, current implementations of semantic image segmentation may further employ a decoder, taking the output feature map from the encoder, to up-sample the final result of the encoder. The up-sampling may include a series of decoding layers that may convert a lower resolution image to a higher resolution image until reaching the resolution of the original input image. In some implementations, the decoding layers may include applying a kernel filter to the lower resolution image at a fractional step (e.g., at ¼ step along x and y directions).

The encoder and decoder together form an encoder and decoder network. While kernels of the encoder can be learned in a training process using training data sets where different kernels are designed for different classes of objects, the decoder is typically not trained in advance and is hard to train in practice. Further, current implementations of decoder are decoupled and independent from the encoder. For these reasons, the decoder often is not tuned to an optimal state, thus becoming the performance bottleneck of the encoder-decoder network.

To overcome the above-identified and other deficiencies, implementations of the present disclosure provide a system and method that may derive the kernel filters W′ of the decoding layers of the decoder directly from corresponding kernel filters W of the convolutional layers of the encoder. In this way, the decoder may be, without training, quickly constructed based on the encoder. Experiments show that the encoder-decoder network including a decoder derived from an encoder may achieve excellent semantic image segmentation performance using a small set of parameters.

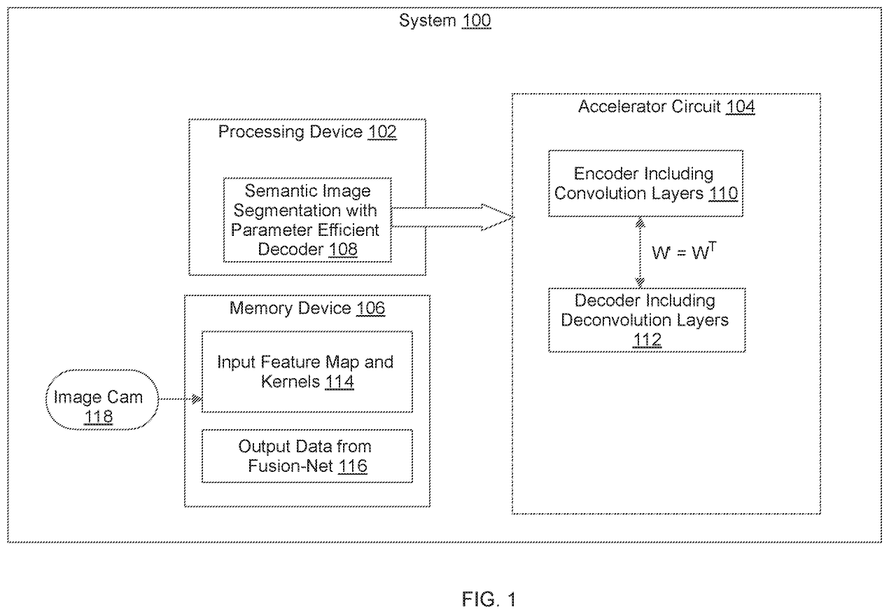

A computer system may be used to implement the disclosed system and method. FIG. 1 illustrates a system 100 for semantic image segmentation according to an implementation of the present disclosure. As shown in FIG. 1, system 100 may include a processing device 102, an accelerator circuit 104, and a memory device 106. System 100 may optionally include sensors such as, for example, an image camera 118. System 100 can be a computing system (e.g., a computing system onboard autonomous vehicles) or a system-on-a-chip (SoC). Processing device 102 can be a hardware processor such as a central processing unit (CPU), a graphic processing unit (GPU), or a general-purpose processing unit. In one implementation, processing device 102 can be programmed to perform certain tasks including the delegation of computationally-intensive tasks to accelerator circuit 104.

Accelerator circuit 104 may be communicatively coupled to processing device 102 to perform the computationally-intensive tasks using the special-purpose circuits therein. The special-purpose circuits can be an application specific integrated circuit (ASIC), a field programmable gate array (FPGA), a digital signal processor (DSP), network processor, or the like. In one implementation, accelerator circuit 104 may include multiple calculation circuit elements (CCEs) that are units of circuits that can be programmed to perform a certain type of calculations. For example, to implement a neural network, CCE may be programmed, at the instruction of processing device 102, to perform operations such as, for example, weighted summation, convolution, dot product, and activation functions (e.g., ReLU). Thus, each CCE may be programmed to perform the calculation associated with a node of the neural network; a group of CCEs of accelerator circuit 104 may be programmed as a layer (either visible or hidden layer) of nodes in the encoder-decoder network; multiple groups of CCEs of accelerator circuit 104 may be programmed to serve as the layers of nodes of the encoder-decoder networks. In one implementation, in addition to performing calculations, CCEs may also include a local storage device (e.g., registers) (not shown) to store the parameters (e.g., kernels and feature maps) used in the calculations. Thus, for the conciseness of description, each CCE in this disclosure corresponds to a circuit element implementing the calculation of parameters associated with a node of the encoder-decoder network. Processing device 102 may be programmed with instructions to construct the architecture of the encoder-network and train the encoder-decoder network for a specific task.

Memory device 106 may include a storage device communicatively coupled to processing device 102 and accelerator circuit 104. In one implementation, memory device 106 may store input data 114 to a semantic image segmentation program 108 executed by processing device 102 and output data 116 generated by executing the semantic image segmentation program 108. The input data 114 can be the image (referred to as the feature map) at a full resolution captured by image camera 118. Further, the input data 114 may include filters (referred to as kernels) that had been trained using an existing database (e.g., the publicly-available ImageNet database). The output data 116 may include the intermediate results generated by executing the semantic image segmentation program and the final segmentation result. The final result can be a feature map having a resolution as the original input image with each pixel labeled as belonging to a specific class of objects.

In one implementation, processing device 102 may be programmed to execute the semantic image segmentation program 108 that, when executed, may detect different classes of objects based on the input image. As discussed above, the object detection using a fully connected neural network applied on a full-resolution image frame captured by video cameras 118 consumes a large amount of computing resource. Instead, implementations of the disclosure use semantic image segmentation including an encoder-decoder network to achieve object detection. The filter kernels of the decoder of the present disclosure is directly constructed from the filter kernels used in the encoder. The construction of the decoder does not require a training process. Such constructed decoder may achieve good performance without the need for training.

Referring to FIG. 1, semantic image segmentation program 108 executed by processing device 102 may include an encoder-decoder network. In one implementation, the convolutional layers of encoder 110 and decoder 112 may be implemented on accelerator circuit 104 to reduce the computational burden on processing device 102. Alternatively, the convolutional layers of encoder 110 and decoder 112 can be implemented on processing device 102 when the accelerator circuit 104 is unavailable.

According to an implementation, the input image may include an array of pixels with a width (W) and a height (H) measured in terms of numbers of pixels. The image resolution may be defined as pixels per unit area. Thus, the higher W and/or H, the higher image resolution. For a color image, each pixel may include a number of channels (e.g., RGB representing the intensity values for red, green, blue color components, and/or range data values). Thus, the input image at the full resolution can be represented as a tensor represented as I(p(y, x), c), where p represents a pixel, x is the index value along the x axis, y is the index value along the y axis. Each pixel may be associated with three color values c(r, g, b) corresponding to the channels (R, G, B). Thus, I is a tensor data object (or three-layered 2D arrays). The encoder 110 may include a series of convolutional layers. A convolutional layer L may be represented as L=Convolution2D(c₁, c₂, (m, n)) with a unit stride, where c₁ is the number of input channels to the layer, c₂ is the number of output channels of the layer, m is the filter kernel height, and n is the filter kernel width. Each layer may receive an input feature map represented as A ∈ R^{h×w×c1}. A given layer L may produce an output feature map B ∈ [symbol] ^{h×w×c2}, where the number (c₂) of channels in the output feature map may be different from the number (c₁) of channels in the input feature map. The output feature map may be further down-sampled to a tensor

$$C ∈ {ℜ}^{\frac{h}{s} \times \frac{w}{t} \times c 2}$$

through a pooling operation with strides s and t.

A corresponding decoder layer may use interpolation to transform C back to a feature map A′∈R^{h×w×c1} that has the same dimension as A. Processing device 102 may perform the interpolation after the calculation by the convolutional layer. The interpolation first converts C to a tensor B′ ∈R^{h×w×c1} that has the same dimension as B.

If c₁=c₂ (i.e., L neither expands nor contracts the channel dimension), implementations of the disclosure use the convolutional layer L as the corresponding decoding layer L′ rather than adding a new layer. When convolutional layer L changes the channel dimension (i.e., c₁≠c₂), the convolutional layer L may not be used directly as the decoding layer L′. Instead, the decoding layer L′ may be derived from the corresponding convolutional layer L.

To transform from A to B, the underlying convolutional layer L may use a weight tensor W ∈ R^{h×w×c2} as the transformation tensor applied to A. Likewise, to transform from B′ to A′, the underlying transformation may require a weight tensor W′ ∈ R^{h×w×c1}. There are many ways to derive W′ from W. In one implementation, W′ is derived from W by permutating the dimensions of W so that W has the same dimensions as W's requires. In other words, W′ ∈R^{h×w×c1} can be derived by swapping the input channel dimension c₁ and the output channel dimension c₂ for W ∈ R^{h×w×c2}. Thus, a convolutional layer is capable of projecting features to a different dimension in a forward pass by applying W and reverse the effect in an opposite backward pass by applying W′. The W′ as derived from W may preserve the inner structure of the original convolution filters in W.

In specific, W ∈ R^{h×w×c2} can be represented as a filter matrix W_{F} ∈ R^{h×w×c2} whose entries are convolutional filters F_{i,j} ∈R^{h×w}, where 0≤i<c₁ and 0≤j<c₂. In the forward pass of the encoder, each column of filters in W_{F} works as a group to output a single number at each spatial location (e.g., each pixel location). For the backward pass of the decoder, W′_{F} ∈R^{c2×c1} is derived by transposing W_{F} ∈R^{c1×c2} by swapping the input channel dimension and the output channel dimension of W ∈R^{h×w×c1×c2}. Because each column in W′_{F} was once a row in W_{F}, grouping the convolutional filters of W′_{F} into columns is equivalent to grouping the convolutional filters of W into rows. This means that the convolutional weights are used both in channel expansion and channel contraction through regrouping while their values are kept intact.

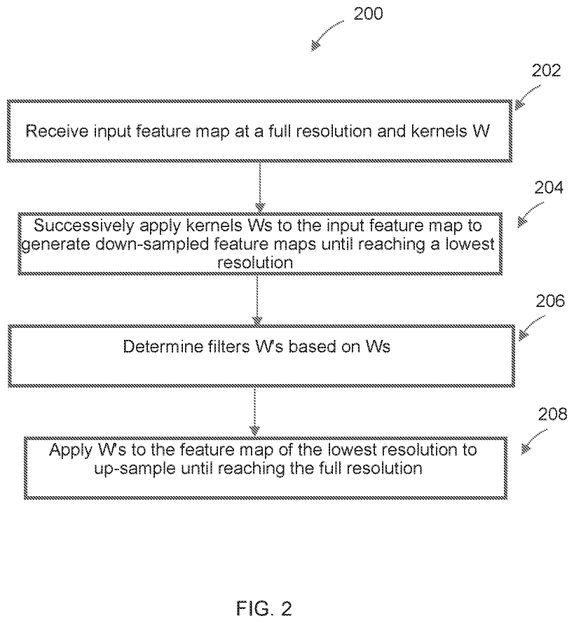

FIG. 2 depicts a flow diagram of a method 200 to detect objects in an image using semantic image segmentation including a feedbackward decoder according to an implementation of the present disclosure. Method 200 may be performed by processing devices that may comprise hardware (e.g., circuitry, dedicated logic), computer readable instructions (e.g., run on a general purpose computer system or a dedicated machine), or a combination of both. Method 200 and each of its individual functions, routines, subroutines, or operations may be performed by one or more processors of the computer device executing the method. In certain implementations, method 200 may be performed by a single processing thread. Alternatively, method 200 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 200 may be performed by a processing device 102 executing semantic image segmentation program 108 and accelerator circuit 104 as shown in FIG. 1.

At 202, the processing device may receive an input image (feature map) at a full resolution and filter kernels Ws that had been trained to detect objects in different classes. The input image may be a 2D array of pixels, each pixel including a preset number of channels (e.g., RGB). The filter kernels may include 2D array of parameter values that may be applied to pixels of the input image in a filter operation (e.g., convolution operations).

At 204, the processing device may execute an encoder including multiple convolutional layers. Through these convolutional layers, the processing device may successively apply filter kernels Ws to the input feature map and then down-sample the filtered feature maps until reaching the lowest resolution result. In one implementation, each convolution layer may include the application of one or more filter kernels to the feature map and down-sampling of the filtered feature map. Through the applications of convolution layers, the resolution of the feature map may be reduced to a target resolution.

At 206, the processing device may determine the filter kernel W's for the decoder in a backward pass. The decoder filters are applied to increase the resolution of the filtered feature maps from the target resolution (which is the lowest) to the resolution of the original feature map (which is the input image). As discussed above, the encoder may include a series of filter kernels Ws that each may have a corresponding W′ that may be derived directly from the corresponding W. In one implementation when the number of channels changes through the forward filtering, elements of W's can be derived by swapping the columns with rows of the corresponding Ws.

At 208, the processing device may execute the decoder including multiple decoding layers. Through these decoding layers, the processing device may first up-sample a lower resolution feature map using interpolation and then apply the W's filter kernel to the feature map. This process starts from the lowest resolution feature map until reaching the full resolution of the original image to generate the final object detection result.

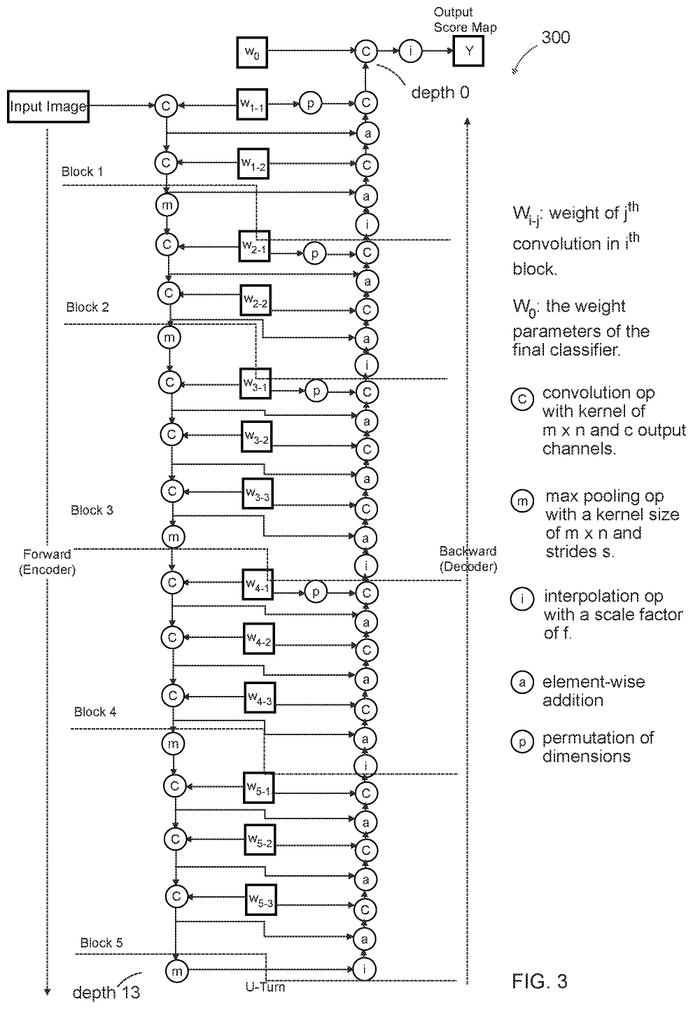

Implementations of the disclosure may achieve significant performance improvements over existing methods. In one implementation as shown in FIG. 3, the disclosed semantic image segmentation is constructed to include 13 convolutional layers in the forward pass of the encoder. The convolutional layers may include filter kernel W. The decoder may also include 13 decoding layers whose filters W's are derived by transposing the weights of W. Each layer in the encoder-decoder network may be followed by an activation function of ReLU except that the last one is followed by a SoftMax operation. There is one more layer (14^{th} layer) in the decoder that is trained from scratch for object classification.

FIG. 3 illustrates an encoder-decoder network 300 according to an implementation of the disclosure. The encoder-decoder network 300 can be an implementation of deep learning convolutional neural network. As shown in FIG. 3, the forward pass (the encoder stage) may include 13 convolution layers divided into five blocks (block 1-5). The input image may include an array of pixels (e.g., 1024×2048 pixels), where each pixel may include multiple channels of data values (e.g., RGB). The input image may be fed into the forward filter pipeline including 13 convolution layers of filter operations. Each convolution layer may apply a filter kernel W₁₋ⱼ to an input feature map received from a prior convolution layer, where i represents the block identifier (i=1, . . . , 5), and j represents the j^{th} convolution within the i^{th} block. The input feature map for convolution layer 1 is the input image, and the filtered output of convolution layer 1 can be the input feature map for convolution layer 2 in block 1. The filter kernel W_{i,j} may be applied to each pixel of the input feature map. If a filter kernel may maintain or change the number of channels from the input feature map to the output feature map. Further, each convolution layer may further include a normalization operation to remove bias generated by the convolution layer.

The transitions between blocks (e.g., from block 1 to block 2, from block 2 to block 3, from block 3 to block 4, and from block 4 to block 5) in the forward pass may include a maximum pooling operation that may down sample the feature map, reducing the resolution of the feature map. Thus, the input image may undergo convolution and down-sample operations in the encoder forward pass, which reduces the resolution of the input image to a minimum target resolution. The output of the encoder may be fed into the decoder backward pass.

The backward pass may convert the feature map from the target minimum resolution back to the full resolution of the input image using interpolation, accumulation, and filter (convolution) operations. The backward pass may correspondingly include 13 convolution layers. Each of the 13 convolution layers in the decoder is matched with a corresponding one in the encoder. Additionally, the backward pass may include interpolation and accumulation operations. While in the forward passing, the adjacent blocks are separated by a max pooling. In the backward passing, the adjacent blocks are separated by an interpolation. In one example, the interpolation can be achieved by the nearest neighbor interpolation. The interpolation operation may increase the resolution of a feature map by up-sampling from a lower resolution to a higher resolution at the boundaries between blocks. The accumulation operation may perform pixel-wise addition of a feature map in the forward pass with the corresponding feature map in the backward pass. For example, once reaching the last layer (at the U-Turn), a down-sampling followed by an up-sampling reverses the direction of information flow. Feature maps at depth d in the backward pass are added with ones at depth d-1 from the forward pass in an accumulation operation to form a fused feature map. The only exception is the feature maps at depth 0 which are directly fed into the final classifier. The fused feature maps at depth d are then fed into a convolutional layer at depth d-1 in the backward pass to generate the feedbackward features at depth d-1.

In the backward pass, instead of independently generating the filter kernels (e.g., through independent training process) for the convolution layers, the filter kernels can be derived from the filter kernels used in the corresponding convolution layer of the forward pass. If the convolution layer in the backward pass does not change the channel dimension (i.e., the number of channels for the input feature map is the same as the output feature map through the convolution layer), the filter kernel W_{i,j}′ in the backward pass may use the same corresponding filter kernel Wᵢ₋ⱼ in the forward pass without change. If the convolutional layer in the backward pass changes the channel dimensions (e.g., from c1 to c2), then the data elements of filter kernel Wᵢ₋ⱼ′ in the backward pass may be a permutation of data elements in the corresponding filter kernel Wᵢ₋ⱼ in the forward pass (e.g., W_{i,j} can be a transpose of W_{i,j}). In this way, the filter kernels of the backward pass may be directly derived from those of the forward pass without the need for a training process while still achieving good performance for the encoder and decoder network.

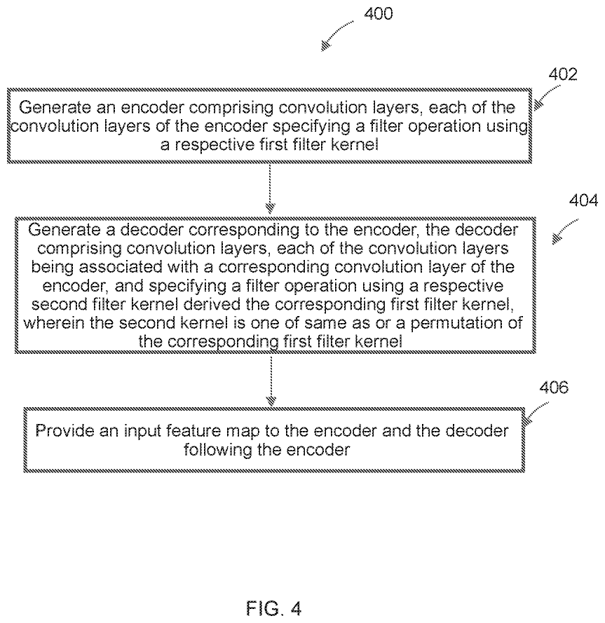

FIG. 4 depicts a flow diagram of a method 400 to construct an encoder and decoder network and apply the encoder and decoder to an input image for semantic image segmentation according to an implementation of the present disclosure. Method 400 may be performed by processing devices that may comprise hardware (e.g., circuitry, dedicated logic), computer readable instructions (e.g., run on a general purpose computer system or a dedicated machine), or a combination of both. Method 200 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method.

Referring to FIG. 4, at 402, the processing device may generate an encoder comprising convolution layers. Each of the convolution layers of the encoder may specify a filter operation using a respective first filter kernel. The convolution layers in the encoder may form a filter operation pipeline in which each convolution layer may receive an input feature map, perform a filter operation by applying the filter kernel of the convolution layer on the input feature map to generate an output feature map, and provide the output feature map as an input feature map to the next convolution layer in the filter operation pipeline of the encoder. Along the filter operation pipeline, the encoder may also include down-sampling operations (e.g., the maximum pooling operation) to decrease the resolution of the input feature map. The filter operation pipeline of the encoder may eventually generate a feature map of a target minimum resolution. In one implementation, the filter kernels in the filter operation pipeline of the encoder are trained using a training dataset (e.g., the publicly available ImageNet dataset) for object recognition.

At 404, the processing device may generate a decoder corresponding to the encoder. The decoder may also include convolution layers, where each of the convolution layers of the decoder may be associated with a corresponding convolution layer of the encoder. Thus, as shown in FIG. 3, if the encoder includes 13 convolution layers, the decoder may also include 13 convolution layers that may each be associated with a corresponding convolution layer of the encoder. Each of the convolution layer of the decoder may specify a filter operation using a respective second filter kernel, where the second filter kernel is derived from the first filter kernel used in the corresponding convolution layer of the encoder. The second filter kernel can be a copy of the corresponding first filter kernel if the first filter kernel does not change the number of channels in the filter operation. Alternatively, the data elements of the second filter kernel is a permutation of data elements of the corresponding first filter kernel if the first filter kernel change the number of channels in the filter operation. In one example, the second filter kernel is a transpose of the first filter kernel. Because the second filter kernels are derived from the corresponding first filter kernels directly, the second filter kernels can be constructed without the training process.

The filter operation pipeline of the decoder may receive, as an input, the output feature map with the lowest resolution generated by the encoder. The decoder may perform filter operation using the convolution layers in the decoder. The convolution layers in the decoder may form a filter operation pipeline in which each convolution layer may receive an input feature map, perform a filter operation by applying the filter kernel of the convolution layer on the input feature map to generate an output feature map, and provide the output feature map as an input feature map to the next convolution layer in the filter operation pipeline of the decoder. Along the filter operation pipeline, the decoder may also include up-sampling operations (e.g., the interpolation operation) to increase the resolution of the input feature map. In one implementation, the up-sampling operation in the decoder is placed at a same level of a corresponding down-sampling operation in the encoder. For example, as shown in FIG. 3, the maximum pooling operations (down-sampling) are placed at the same levels as interpolation operations (up-sampling).

At 406, the processing device may provide an input image to the encoder and decoder network to perform a semantic segmentation of the input image. The output feature map generated by the encoder followed by the decoder may be fed into a trained classifier that may label each pixel in the input image with a class label. The class label may indicate that the pixel belongs to a certain object in the input image. In this way, each pixel in the input image may be labeled as associated with a certain object using the encoder and decoder network, where the filter kernels of the decoder are derived from the filter kernels in the encoder directly.

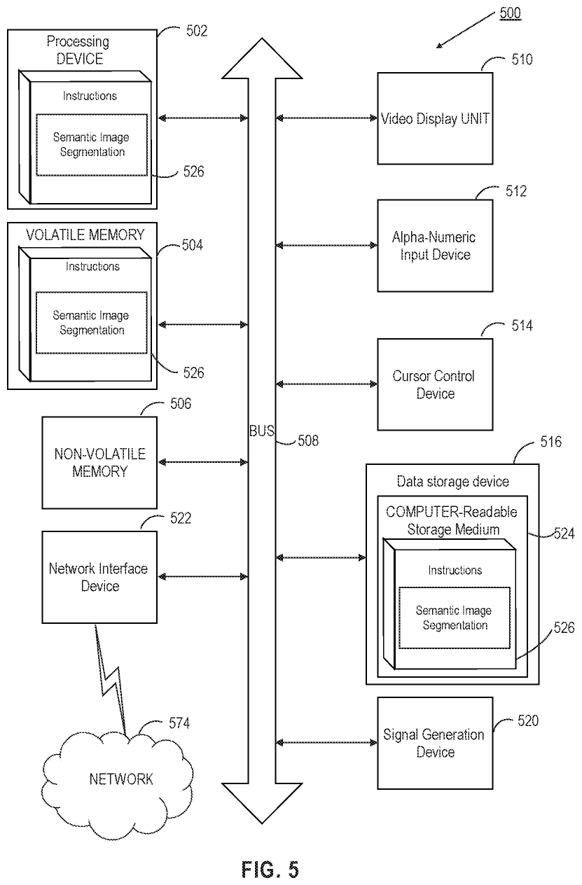

FIG. 5 depicts a block diagram of a computer system operating in accordance with one or more aspects of the present disclosure. In various illustrative examples, computer system 500 may correspond to the system 100 of FIG. 1.

In certain implementations, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., random access memory (RAM)), a non-volatile memory 506 (e.g., read-only memory (ROM) or electrically-erasable programmable ROM (EEPROM)), and a data storage device 516, which may communicate with each other via a bus 508.

Processing device 502 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 may further include a network interface device 522. Computer system 500 also may include a video display unit 510 (e.g., an LCD), an alphanumeric input device 512 (e.g., a keyboard), a cursor control device 514 (e.g., a mouse), and a signal generation device 520.

Data storage device 516 may include a non-transitory computer-readable storage medium 524 on which may store instructions 526 encoding any one or more of the methods or functions described herein, including instructions of the semantic image segmentation program 108 of FIG. 1 for implementing method 200 or 400.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 200 or 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method for constructing an encoder and decoder neural network for providing semantic image segmentation, the method comprising:
generating, by a processing device, an encoder comprising encoding convolution layers, each of the encoding convolution layers specifying an encoding filter operation using a respective first filter kernel;
generating, by the processing device, a decoder corresponding to the encoder, the decoder comprising decoding convolution layers, each of the decoding convolution layers being associated with a corresponding encoding convolution layer, and each of the decoding convolution layers specifying a decoding filter operation using a respective second filter kernel derived from the first filter kernel of the corresponding encoder convolution layer; and
providing, by the processing device, an input image to the encoder and the decoder for semantic image segmentation.

2. The method of claim 1, wherein generating, by a processing device, an encoder comprising encoding convolution layers, each of the encoding convolution layers specifying an encoding filter operation using a respective first filter kernel further comprises:
providing down-sampling operations in the encoder, wherein each of the down-sampling operations is to generate an output feature map with a lower resolution than that of an input feature map.

3. The method of claim 2, wherein generating, by the processing device, a decoder corresponding to the encoder, the decoder comprising decoding convolution layers, each of the decoding convolution layers being associated with a corresponding encoding convolution layer, and each of the decoding convolution layers specifying a decoding filter operation using a respective second filter kernel derived from the first filter kernel of the corresponding encoder convolution layer further comprises:
providing up-sampling operations in the decoder, where each of the up-sampling operation is to generate an output feature map with a higher resolution than that of an input feature map.

4. The method of claim 3, wherein the encoder is to reduce a resolution of the input image through the encoding convolution layers and the down-sampling operations to a target output feature map having a lowest resolution, and wherein the decoder is to increase a resolution of the target output feature map through the decoding convolution layers and the up-sampling operations to a final output feature map with a resolution same as that of the input image.

5. The method of claim 4, further comprising:
providing the final output feature map of the encoder and decoder neural network to a classifier to label each pixel with an object class.

6. The method of claim 1, wherein the first filter kernels are determined by a training processing using a training dataset, and wherein the second filter kernels are derived from the first filter kernels without undergoing the training process.

7. The method of claim 1, wherein each of the second filter kernel is one of a same as or a permutation of the corresponding first kernel filter.

8. The method of claim 1, wherein generating, by the processing device, a decoder corresponding to the encoder, the decoder comprising decoding convolution layers, each of the decoding convolution layers being associated with a corresponding encoding convolution layer, and each of the decoding convolution layers specifying a decoding filter operation using a respective second filter kernel derived from the first filter kernel of the corresponding encoder convolution layer further comprises: for each of the decoding convolution layers,
identifying a corresponding encoding convolution layer;
determining if the first filter kernel of the corresponding convolution layer changes a number of channels through the corresponding convolution layer;
responsive to determining that the number of channels does not change, setting the second filter kernel of the decoding convolution layer same as the first filter kernel; and
responsive to determining that the number of channels changes, setting the second filter kernel of the decoding convolution layer as a permutation of the first filter kernel.

9. A system, comprising:
a memory device to store an input image;
an accelerator circuit for implementing an encoder and decoder neural network for providing semantic image segmentation; and
a processing device, communicatively coupled to the memory device and the accelerator circuit, to:
generate, on the accelerator circuit, an encoder comprising encoding convolution layers, each of the encoding convolution layers specifying an encoding filter operation using a respective first filter kernel;
generate, on the accelerator circuit, a decoder corresponding to the encoder, the decoder comprising decoding convolution layers, each of the decoding convolution layers being associated with a corresponding encoding convolution layer, and each of the decoding convolution layers specifying a decoding filter operation using a respective second filter kernel derived from the first filter kernel of the corresponding encoder convolution layer; and
provide the input image to the encoder and the decoder for semantic image segmentation.

10. The system of claim 9, wherein to generate, on the accelerator circuit, an encoder comprising encoding convolution layers, each of the encoding convolution layers specifying an encoding filter operation using a respective first filter kernel, the processing device is further to:
provide down-sampling operations in the encoder, wherein each of the down-sampling operations is to generate an output feature map with a lower resolution than that of an input feature map.

11. The system of claim 10, wherein to generate, on the accelerator circuit, a decoder corresponding to the encoder, the decoder comprising decoding convolution layers, each of the decoding convolution layers being associated with a corresponding encoding convolution layer, and each of the decoding convolution layers specifying a decoding filter operation using a respective second filter kernel derived from the first filter kernel of the corresponding encoder convolution layer, the processing device is further to:
provide up-sampling operations in the decoder, where each of the up-sampling operation is to generate an output feature map with a higher resolution than that of an input feature map.

12. The system of claim 11, wherein the encoder is to reduce a resolution of the input image through the encoding convolution layers and the down-sampling operations to a target output feature map having a lowest resolution, and wherein the decoder is to increase a resolution of the target output feature map through the decoding convolution layers and the up-sampling operations to a final output feature map with a resolution same as that of the input image.

13. The system of claim 12, wherein the processing device is further to provide the final output feature map of the encoder and decoder neural network to a classifier to label each pixel with an object class.

14. The system of claim 9, wherein the first filter kernels are determined by a training processing using a training dataset, and wherein the second filter kernels are derived from the first filter kernels without undergoing the training process.

15. The system of claim 9, wherein each of the second filter kernel is one of a same as or a permutation of the corresponding first kernel filter.

16. The system of claim 9, wherein to generate, on the accelerator circuit, a decoder corresponding to the encoder, the decoder comprising decoding convolution layers, each of the decoding convolution layers being associated with a corresponding encoding convolution layer, and each of the decoding convolution layers specifying a decoding filter operation using a respective second filter kernel derived from the first filter kernel of the corresponding encoder convolution layer, the processing device is further to: for each of the decoding convolution layers,
identify a corresponding encoding convolution layer;
determine if the first filter kernel of the corresponding convolution layer changes a number of channels through the corresponding convolution layer;
responsive to determining that the number of channels does not change, set the second filter kernel of the decoding convolution layer same as the first filter kernel; and
responsive to determining that the number of channels changes, set the second filter kernel of the decoding convolution layer as a permutation of the first filter kernel.

17. A non-transitory machine-readable storage medium storing instructions which, when executed, cause a processing device to perform operations of constructing an encoder and decoder neural network for providing semantic image segmentation, the operations comprising:
generating, by the processing device, an encoder comprising encoding convolution layers, each of the encoding convolution layers specifying an encoding filter operation using a respective first filter kernel;
generating, by the processing device, a decoder corresponding to the encoder, the decoder comprising decoding convolution layers, each of the decoding convolution layers being associated with a corresponding encoding convolution layer, and each of the decoding convolution layers specifying a decoding filter operation using a respective second filter kernel derived from the first filter kernel of the corresponding encoder convolution layer; and
providing, by the processing device, an input image to the encoder and the decoder for semantic image segmentation.

18. The non-transitory machine-readable storage medium of claim 17, wherein generating, by a processing device, an encoder comprising encoding convolution layers, each of the encoding convolution layers specifying an encoding filter operation using a respective first filter kernel further comprises providing down-sampling operations in the encoder, wherein each of the down-sampling operations is to generate an output feature map with a lower resolution than that of an input feature map, and wherein generating, by the processing device, a decoder corresponding to the encoder, the decoder comprising decoding convolution layers, each of the decoding convolution layers being associated with a corresponding encoding convolution layer, and each of the decoding convolution layers specifying a decoding filter operation using a respective second filter kernel derived from the first filter kernel of the corresponding encoder convolution layer further comprises providing up-sampling operations in the decoder, where each of the up-sampling operation is to generate an output feature map with a higher resolution than that of an input feature map.

19. The non-transitory machine-readable storage medium of claim 18, wherein the encoder is to reduce a resolution of the input image through the encoding convolution layers and the down-sampling operations to a target output feature map having a lowest resolution, and wherein the decoder is to increase a resolution of the target output feature map through the decoding convolution layers and the up-sampling operations to a final output feature map with a resolution same as that of the input image.

20. The non-transitory machine-readable storage medium of claim 17, wherein each of the second filter kernel is one of a same as or a permutation of the corresponding first kernel filter.
